(19) United States
(12) Patent Application Publication
(10) Pub. No.: US 2012/0225748 A1
(43) Pub. Date: Sep. 6, 2012

(54) ADAPTIVE TRANSMISSION

(75) Inventors: Frank Michel, Weikersheim (DE); Thomas Wimmer, Tauberrettersheim (DE)

(73) Assignee: WITTENSTEIN AG, Igersheim (DE)

(21) Appl. No.: 13/343,175

(22) Filed: Jan. 4, 2012

(30) Foreign Application Priority Data
Mar. 2, 2011 (DE) 102011001039.4

(51) Int. Cl. F16H 57/08; F16H 55/12

(52) U.S. Cl. 475/331; 74/446

(57) ABSTRACT

A machine element, in particular ring gear for a transmission (1, 31) having an internal toothing arrangement (40), wherein the machine element is divided, in a plane perpendicular to an axis (22) of the machine element, into at least two component pieces (11, 12) which can be displaced relative to one another and which are mounted on a common carrier element (20), having an actuator (15-18) for displacing a first of the component pieces (11, 12) relative to the carrier element (20).

### BACKGROUND OF THE INVENTION

The invention relates to a machine element comprising a ring gear for a transmission and to a method for operating the transmission.

In transmissions, a small amount of rotational face clearance is required, in particular for precision actuating drives. However, at the same time the internal friction of the transmission should be as low as possible in order to minimize losses and to prevent heat from being generated in the transmission.

EP 1 236 929 A1 discloses dividing a ring gear of a planetary gear mechanism into two component pieces which can be rotated with respect to one another by means of an actuating screw. This provides a possible way of reducing the clearance of the planetary gear mechanism.

In particular in the case of planetary gear mechanisms there is also the problem that the various gear wheels, specifically the sun gear, the planetary gears and the ring gear constitute a statically overdetermined system, which can lead to a situation in which a transmission which is not oriented in a highly precise fashion distributes the load unevenly over the circumference of the ring gear and different degrees of wear occur after a certain operating period. Basically, there is a need to make available planetary gear mechanisms with the longest possible service life, small clearance and low internal friction.

The object of the invention is to improve machine elements, known from the prior art, for transmissions. In particular, an object of the invention is to achieve a reduction in clearance, to improve the positional accuracy or to increase the service life of machine elements or transmissions.

### SUMMARY OF THE INVENTION

The object is achieved with a ring gear of the present invention and a method.

The carrier element is preferably embodied in a fixed fashion or as a fixed bearing. The machine element is particularly suitable for a transmission with an internal toothing arrangement, for example a planetary gear mechanism, a sliding wedge transmission with a flexible gear rim or a transmission with an internal cam disk and radially movable teeth. Preferred embodiments of the machine element have teeth for a toothing arrangement with a gear wheel. A preferred example of the machine element is a gear wheel, wherein the term “gear wheel” typically also includes a ring gear with an internal toothing arrangement. The machine element preferably comprises two component pieces or halves, wherein embodiments with three or more component pieces are also possible. Each of the component pieces is preferably embodied with a gear rim all around it. The expression “gear rim” also includes an internal toothing arrangement. The component pieces can be displaced relative to one another. In this context, the expression “can be displaced” is to be understood in a general way, so that the expression “can be displaced” in this context includes both a translatory or axial displacement as well as a rotational displacement. The component piece can preferably be displaced in at least one of the abovementioned directions. An actuator is provided for displacing a first of the component pieces relative to the carrier element, and therefore also relative to the second of the component pieces. The actuator can preferably be actuated electrically.

The component pieces are advantageously arranged in such a way that clearance of the transmission can be changed by a relative displacement of the component pieces. The displacement of the first component piece with the actuator provides the advantage that the clearance of a transmission can be reduced with the machine element, rigidity of a transmission can be increased with the machine element, the synchronized running or the true running can be improved and furthermore softness at the zero crossing can be eliminated.

In further embodiments of the invention, the carrier element is embodied as a moving part, in particular as a shaft. Although this embodiment has the disadvantage that control lines or energy supply lines of the actuator have to be routed from a routing shaft to a fixed contact, this embodiment provides a large degree of freedom in terms of the adaptation of the transmission to various operating situations. The carrier element is preferably rigid, that is to say is embodied as a rigid shaft or as a rigid fixed bearing. The term rigid means here that the rigidity of the carrier element corresponds essentially to a degree of rigidity such as is customary in a shaft or bearing which would otherwise occur or be used at this location.

The actuator is preferably suitable for displacing the first component piece by at maximum 1.5 teeth of the machine element which is embodied as a gear wheel. This preferably applies to a translatory displacement or to a rotational displacement or to both types of displacement. The actuator is even more preferably configured to displace the first component piece by a maximum of 1.1 teeth, most preferably by a maximum of 0.6 or 0.3 teeth. Preferred maximum possible rotational displacements are at maximum 1° or more preferably at maximum 0.5°. A small displacement path means a small embodiment of the actuator and further the possibility of being able to approach end positions even within a short time.

The component piece is preferably connected to the carrier element via at least three actuators. Three actuators provide the advantage that they define a plane with their stopping points and provide sufficient rigidity and reliability in terms of positioning. The actuators are preferably arranged in such a way that they permit displacement in the circumferential direction. With at least three actuators, a displacement in all directions in the plane perpendicular to the axis of the machine element is possible, as is a rotational displacement of the component piece. The axis of the machine element typically denotes the rotational axis or the axis of a machine element which is embodied as a gear wheel, or else the axis with respect to which the machine element is at least partially rotationally symmetrical.

In particularly preferred embodiments, the actuators are each provided in pairs, wherein the paired actuators are each arranged running in opposite directions. This provides the advantage that actuators can be used which have a preferred working direction, such as, for example, piezo-actuators. In particularly preferred exemplary embodiments, three, or even more preferably four or more, actuator pairs, which each preferably act in the circumferential direction, are provided. Four actuator pairs provide the advantage of a higher degree of stability of the machine element. The actuators or the actuator pairs are preferably arranged distributed at least essentially uniformly over the circumference. In the context of the actuators which act in the circumferential direction, the machine element preferably has a straight toothing arrangement. In other embodiments, the toothing arrangement of the machine element is preferably oblique. In the context of an oblique toothing arrangement, it is particularly preferred that at least one of the actuators or the actuator is arranged in such a way that it permits an axial displacement of the first component piece relative to the carrier element. In the context of the oblique toothing arrangement it is ensured that clearance of the toothing arrangement can be changed.

The at least three actuators for the first component piece preferably form a first actuator set for displacing the first component piece. In preferred embodiments, a second actuator set is provided for displacing the second component piece relative to the carrier element. The second actuator set in turn preferably comprises at least three actuators, preferably four actuators or four actuator pairs. An arrangement with, in each case, four actuator pairs for each of the two component pieces is particularly preferred, wherein the actuators are each arranged in the circumferential direction or at least essentially in the circumferential direction. In this case, the expression “essentially in the circumferential direction” preferably means an angular range of at maximum +/−20°, more preferably at maximum +/−10° with respect to the circumferential direction. An arrangement of the actuators in the circumferential direction provides the advantage of a space-saving arrangement. Two actuator sets for the two component pieces provide the advantage that a rapid relative displacement of the two component pieces is possible by actuating the two actuator sets in opposite directions.

At least one of the actuators preferably comprises a piezo-element. Piezo-elements provide the advantage that they exhibit a particularly rapid mechanical reaction, with the result that, with actuators which comprise piezo-elements, translatory or rotational displacements of the component pieces are possible with a frequency of up to 100 kHz. The actuators are preferably embodied as piezo-actuators in order to permit rapid displacement of the component pieces. In preferred embodiments, at least one actuator comprises a shape memory alloy. Shape memory alloys provide the advantage that they react to thermal and magnetic change and furthermore are extremely stable.

Typical embodiments of the invention are configured to measure a force with at least one of the actuators. In this way it is possible to determine, for example, a torque which is transmitted by the transmission. Piezo-elements are particularly preferably used as actuators to determine forces which act on the actuators. In preferred methods, the actuators are used in a measuring operating mode as force measuring sensors in order to determine a torque which is transmitted by the transmission.

The machine element is advantageously a ring gear with an internal toothing arrangement. In particular in the case of a fixed ring gear, this provides the advantage that sufficient installation is present to provide the actuators and the carrier element. The carrier element is preferably fixedly connected to a housing of a transmission, part of which is the ring gear, or the carrier element is itself the housing or a part of the housing. This provides the advantage of a particularly compact and stable design.

The invention preferably comprises a control unit for actuating the actuator or actuators. The control unit is preferably configured to actuate the actuators as a function of an input variable. Possible input variables are, in particular, position variables of further gear wheels which engage with the machine element, or drive shafts or output shafts. This permits the actuator to be actuated, with the result that the component pieces are positioned ideally in any position of further gear wheels, for example planetary gears, in order to permit the largest possible degree of freedom from clearance with little wear. Advantageous embodiments comprise a control unit with a memory for storing a characteristic diagram. The control unit is preferably configured to actuate the actuator as a function of an input variable on the basis of data of the characteristic diagram. The data of the characteristic diagram preferably comprise information about geometric irregularities of the machine element or of further gear wheels which are engaged with the machine element. In this way, true running or synchronized running of a transmission can be improved with the machine element, and furthermore the clearance of the transmission can be reduced by adapting the position of the component pieces to the respective position of further gear wheels which engage with the machine element.

One preferred embodiment of the invention is a transmission, in particular a coaxial transmission, having a machine element which is preferably embodied as a ring gear, in one of the above-described embodiments which are preferred or according to the invention. Such a transmission provides the advantage of reduced clearance with improved synchronized running or true running in combination with a high degree of rigidity. The rotational clearance is preferably at maximum 3 angular minutes, more preferably at maximum 1 angular minute or at maximum 0.5 angular minute. In preferred embodiments, the transmission is embodied as a planetary gear mechanism. Embodiments of planetary gear mechanisms in which the machine element is fixed are particularly preferred. A possibility for this is the sun gear which can be divided into two component pieces in embodiments according to the invention in order to permit relative displacement of the two component pieces with respect to one another. Embodiments in which the ring gear is embodied as the fixed machine element are particularly preferred. In this way, a particularly simple design is obtained. Planetary gear mechanisms according to the invention provide the advantage that true running properties can be improved with the aid of the invention. Planetary gear mechanisms are multiply overdetermined systems in which internal stresses can occur owing to fabrication tolerances. Such voltages can be compensated dynamically with the aid of the invention. It is necessary to take into account here the fact that, due to fabrication reasons, the planetary gears can have different tolerance situations or slightly variable radii or tooth geometries over their circumference. Even if these geometric irregularities owing to small fabrication tolerances are extremely minor, they nevertheless have a slight influence on the true running or the clearance depending on the position and angular position of the individual planetary gears. The possibility of dynamically displacing the component pieces depending on the angular position of the planetary gears makes it possible to improve the true running properties of a transmission according to the invention.

Further embodiments according to the invention comprise an internal cam disk, also referred to as a polygon, and a gear rim which is arranged between the machine element, which is embodied as a ring gear, and the cam disk and has radially movable teeth. The teeth can be driven by the cam disk. DE 102006042786 B4 discloses a corresponding transmission, but without the machine element according to the invention. In the invention, the ring gear of the subject matter disclosed in the specified patent is preferably replaced by the machine element, embodied as a ring gear, with at least two component pieces. In this way, by rotating the component pieces in opposite directions it is possible to change the clearance over the circumference, depending on which of the teeth engages with the gear wheel at a particular time.

In further embodiments of the invention, a single-piece ring gear, two gear rims with radially movable teeth, which form the at least two component pieces of the machine element, or two internal cam disks, are provided. In embodiments with two cam disks, said cam disks are typically connected to the same drive shaft, but at least one cam disk is connected to the shaft via actuators, with the result that the cam disks can be rotated with respect to one another. In this way, it is also possible to tension the transmission and reduce the clearance. In typical embodiments, the machine element is formed by the two gear rims with radially movable teeth, wherein in each case at least four teeth are preferably arranged one next to the other in a row in the axial direction of the transmission. Four teeth in a row increase the stability of the toothed bearing beams since in each case two teeth which are arranged in one of the cages of the divided machine element can be mounted together.

For more precise information relating to transmission with an internal cam disk, also referred to as cam disk transmission, reference is made to the patent mentioned above, the content of which is incorporated expressly in this application, in particular with respect to the bearing of the radially movable teeth on the cam disk (reference numbers 7 and 8 of the specified patent), and the bearing of the teeth in the gear rim.

In preferred embodiments of the invention, at least two teeth, preferably at least three or at least four teeth, are arranged one next to the other in the axial direction of the transmission and are combined to form packets. In this way, the stability of the transmission is improved and rotation of the teeth about a radial direction of the transmission, i.e. the longitudinal axis of a tooth, is avoided. Overall, this makes it possible, through interaction with the invention, to provide a transmission with a very high transmission ratio, low clearance and a high degree of rigidity.

A further independent aspect of the invention relates to a method for operating a transmission in one of the above-described preferred embodiments according to the invention. With the method according to the invention, the true running, the synchronized running or the clearance of the transmission is improved or reduced, wherein furthermore the service life can be increased. In particular, the synchronized running, i.e. the clearance profile over one entire rotation, can be improved since with the invention irregularities can be compensated mechatronically. At first, an angular position is determined. An angular position of a drive shaft, of an output shaft, of a planetary carrier or of at least one planetary gear is preferably determined. This angular position or these angular positions form the input variable for the method according to the invention. Depending on the input variable, a setpoint position for at least one of the component pieces of the machine element is determined. On the basis of the input variable it is determined which position the transmission is in at a specific time. The control unit particularly preferably calculates in advance, on the basis of the input variable, future setpoint positions of at least one of the component pieces or of a plurality of component pieces of the machine element in order to actuate the actuators, with the result that at a specific time the component piece assumes a setpoint position which is intended for this time. This provides the advantage that the transmission is set in an optimum way for every time. The characteristic diagram preferably comprises information about geometric irregularities, true running, clearance or other geometric data of components of the transmission such as gear wheels, gear rims or cam disks, for a multiplicity of positions, also referred to as positioning, of the transmission. The control unit is preferably designed to interpolate information from the data from the characteristic diagram for positions of the transmission. This provides the advantage that the memory requirement of the characteristic diagram is reduced. In a further step of the method according to the invention, the actuator or actuators are actuated as a function of the setpoint position. The component pieces are particularly preferably rotated in opposite directions in order to ensure that a specific relative position is approached particularly quickly in order to bring about a specific clearance.

A further preferred application is an improvement or increase in the rigidity of the transmission. Particularly in the case of acceleration and high torques, a higher degree of rigidity is required than, for example, in the case of a constant speed. In order to avoid having to configure the transmission permanently for small deformations when such extreme loading occurs and therefore to avoid having to give it large dimensions, the actuators of the machine element according to the invention can selectively increase the rigidity. The advantage is a low mass of the transmission accompanied by a high degree of rigidity. As a result, the transmission is particularly suitable for multi-axle robots or other applications in which the emphasis is on small moving masses. With the invention it is possible to increase the static and dynamic rigidity of a transmission. For this purpose, the actuators can be actuated as a function of the load or the force at the output. The force or the torque at the output can be measured by means of force sensors which are embodied, for example, as piezo-elements or strain gauges. In typical embodiments, the actuators themselves serve to measure force. The measured forces as actual values permit rapid actuation of the actuators and improved rigidity of the drive during operation. For example, it is possible, in the case of a ring gear which is divided into two component pieces, to rotate the component pieces counter to the load in order to counteract elastic deformation and therefore increase the rigidity.

The method according to the invention preferably comprises an initialization step in which the transmission is operated to determine the characteristic diagram. In this context, angular positions of the machine element or of further components of the transmission are run through in order to determine a comprehensive characteristic diagram. The clearance in a transmission positioning process can be determined by determining the clearance at this position through alternating stress. For example, in the case of a planetary gear mechanism, the planetary gear mechanism is operated in such a way that for combinations of different angular positions of the drive shaft, of the output shaft and of the planetary gears, information is obtained for the characteristic diagram, particularly preferably in angular increments of less than 10°, preferably less than 3° and particularly preferably in angular increments of less than 1°. In this way it is possible to obtain information about the clearance, true running and necessary adaptations for all the positions of the transmission, if appropriate by interpolation. In one embodiment in which the machine element is embodied as a ring gear, the internal gears, for example sun gear and planetary gears or cam disk, are operated with a gear rim, with the result that information about the geometry of the transmission, for example information about the clearance or the true running, is obtained for all the possible angular positions in the above-mentioned angular increments.

A determination of the characteristic diagram is advantageously repeated during operation. The characteristic diagram is particularly preferably determined once more after a certain operating period. In this way, the clearance can be adapted even for a transmission which is already worn through use, with the result that the transmission still has low clearance even after a relatively long service life by virtue of the fact that the actuators are correspondingly actuated. The characteristic diagram is preferably determined again after a certain, previously defined service life. A further preferred possibility is to determine the characteristic diagram again if it is detected that the clearance of the transmission has increased by a specific absolute value. The control unit is preferably able to determine the clearance of the transmission by, for example, the control unit receiving information about the angular position of the drive shaft and of the output shaft.

The transmission is preferably operated in a first mode and subsequently in a second mode, wherein in the first mode and in the second mode the component pieces are each positioned in such a way that clearance of the transmission is greater in the first mode than in the second mode. In this way, a fast gearspeed and a gearspeed for precise positioning can be provided. This provides the advantage of rapid starting from a rough position and subsequent precise positioning with little clearance. The control unit is preferably configured to operate the transmission in the described first mode and in the described second mode.

### BRIEF DESCRIPTION OF THE DRAWINGS

A number of exemplary embodiments of the invention will be explained below on the basis of the appended drawings, in which:

FIG. 1 shows a planetary gear mechanism in a schematic, sectional perspective view with a section perpendicular to the axis of the planetary gear mechanism;

FIG. 2 shows the planetary gear mechanism in FIG. 1 in a schematic sectional view with a sectional plane in which the axis of the planetary gear mechanism is located;

FIG. 3 shows the ring gear of the planetary gear mechanism in FIG. 1 in a schematic sectional view in a section perpendicular to the axis of the ring gear;

FIG. 4 shows a further transmission in a schematic sectional view with a section perpendicular to the axis of the further transmission;

FIG. 5 shows a schematic plan view of a detail of the transmission in FIG. 4;

FIG. 6 shows a schematic view of the planetary gear mechanism in FIG. 1 with a control unit; and

FIG. 7 shows the sequence of a method according to the invention in a schematic flow diagram.

### DETAILED DESCRIPTION

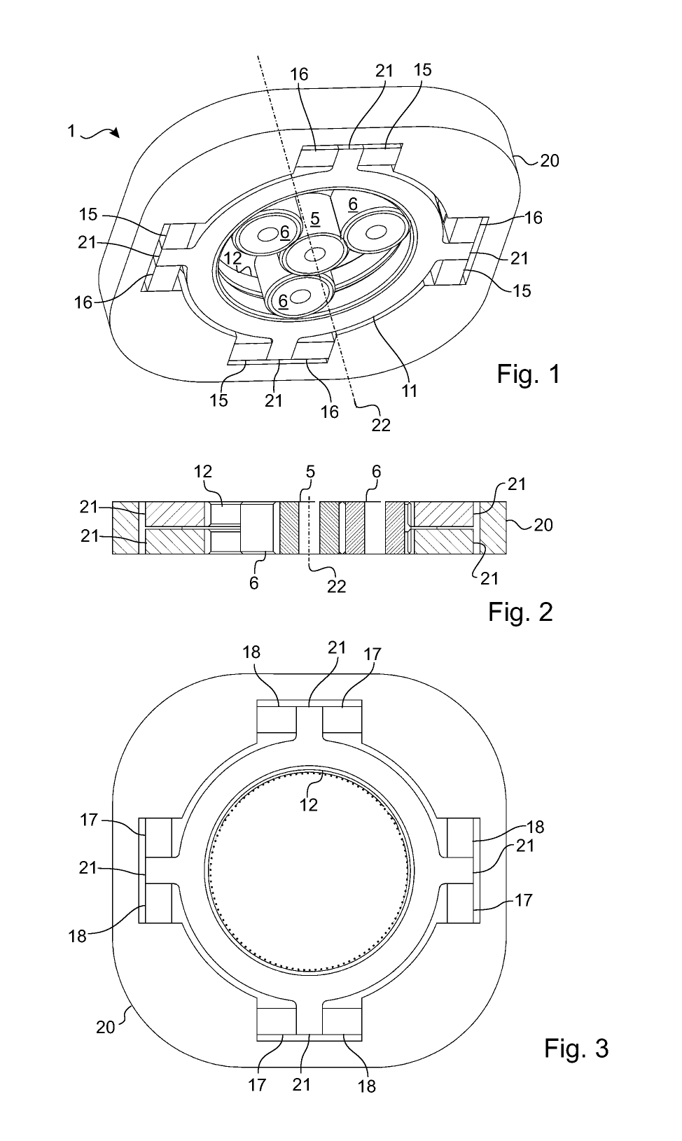

FIG. 1 shows a schematic view of a planetary gear mechanism 1, as the transmission, having a machine element which forms a fixed ring gear of the planetary gear mechanism. The planetary gear mechanism 1 comprises a sun gear 5 and three planetary gears 6 which are arranged around the sun gear 5 and intermesh with it. The planetary gears 6 also intermesh with the internal toothing arrangement of the ring gear. The ring gear comprises two component pieces 11 and 12, which are mounted on a carrier element 20 by means of actuators 15-18. The actuators 15 and 16 hold the component piece 11, and the actuators 17 and 18 (see FIG. 3) hold the component piece 12. The component pieces 11, 12 each have radially protruding noses 21 on which the actuators 15-18, arranged in the circumferential direction, act. In each case four actuators 15, 16, 17 and 18 are present, wherein the actuators 15 and 16 each form four actuator pairs running in opposite directions, and the actuators 17 and 18 each form a further four actuator pairs running in opposite directions. The actuator pairs are arranged distributed evenly over the circumference of the component pieces 11, 12 at an angle of 90°. The actuators 15 and 17 act in one rotational direction, and the actuators 16 and 18 act in the opposite rotational direction. The actuators 15-18 are essentially arranged in the circumferential direction with respect to an axis 22 of the ring gear. The formulation “essentially” allows for the fact that the direction of force at the force action points of the actuators 15-18 is not precisely oriented in the circumferential direction owing to the finite thickness of the noses 21. Since the planetary gear mechanism 1 is a coaxial transmission, the axis 22 is also the central longitudinal axis of the planetary gear mechanism 1 and the rotational axis of the sun gear 5. Furthermore, the rotational axes of the planetary gears 6 rotate about the axis 22.

The actuators 15-18 comprise piezo-elements which can convert electrical energy into mechanical energy. By means of the piezo-elements it is possible for the actuators 15-18 to approach different positions in very short time periods, with the result that the component pieces 11, 12 can be moved, that is to say, for example, rotated to and fro, at frequencies of up to 100 kHz. Likewise, translatory displacements are possible. The restricted travel of the actuators with piezo-elements is at most a slight disadvantage since usually only small displacements may be sufficient to adapt the clearance or for improved true running. In order to simplify the drawings, the toothing arrangements were to a certain extent not shown in the drawings.

In the following description of the further figures, identical reference symbols are used for identical or similar parts. The parts are in some cases not explained once more.

FIG. 2 is a schematic sectional view with a sectional plane in which the axis 22 of the planetary gear mechanism, the planetary gear mechanism 1 in FIG. 1, is located. In the sectional drawing, the noses 21, one of the planetary gears 6 and the sun gear 5 are illustrated in sectional form. Another of the planetary gears 6 is partially covered by the sun gear 5 which is illustrated in section.

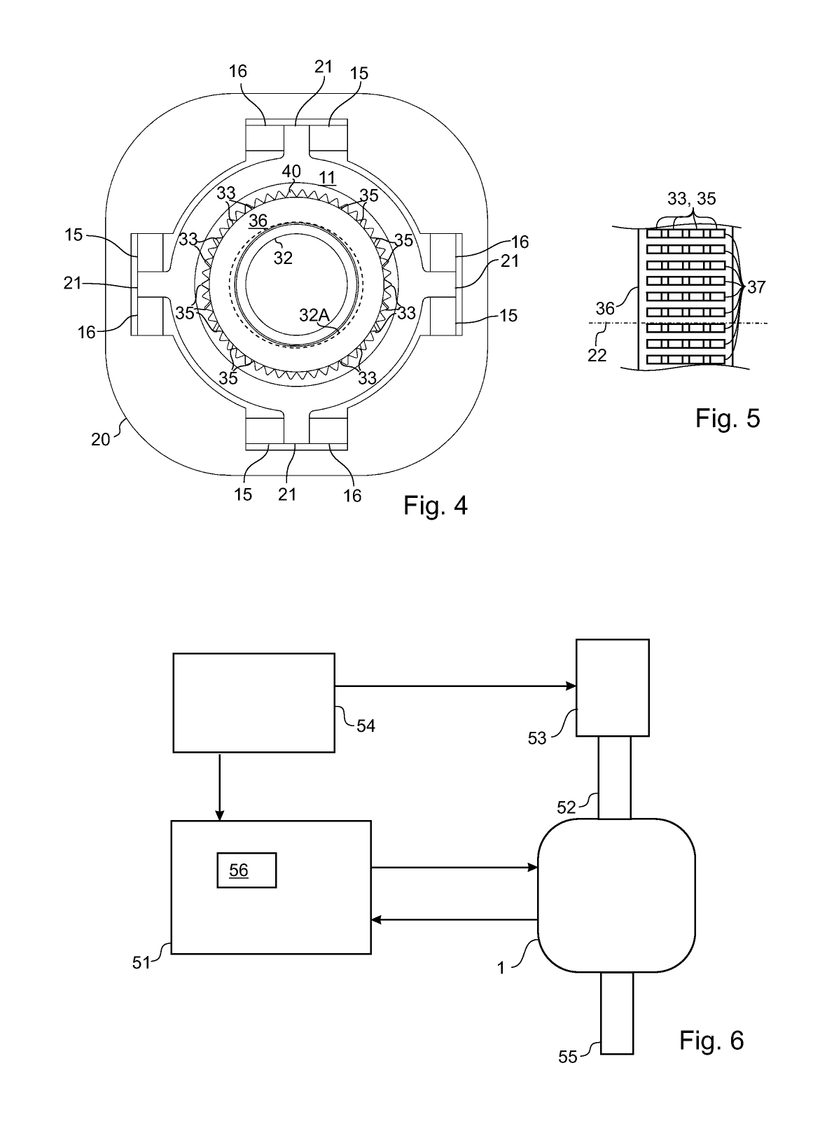

In FIG. 3, the ring gear in FIG. 1 is shown as a machine element according to the invention. FIG. 3 shows the rear view of the ring gear in FIG. 1, with the result that the actuators 17 and 18, which hold the rear component piece 12, are illustrated. The ring gear can also be used in other transmissions with an internal toothing arrangement 40, such as, for example, in transmissions with a stress wedge. A further possibility of use of the ring gear is explained below in relation to FIG. 4.

FIG. 4 shows a cam disk transmission 31 as the transmission, which permits very high transmission ratios of, for example, 50:1. The cam disk transmission 31 comprises a ring gear which corresponds essentially to the ring gear of the planetary gear mechanism 1 in FIG. 1, and at this point will not be completely explained once more. The cam disk transmission 31 comprises, as a drive element, a cam disk 32 which is arranged coaxially with respect to the ring gear and has an ellipsoidal outer contour 32A which is indicated schematically by dashed lines in FIG. 4. When the cam disk 32 rotates, teeth 33 of a gear rim are driven outward in the radial direction and pushed into engagement with the ring gear. At other locations on the circumference of the cam disk 32, other teeth 35 of the gear rim can run back radially inward again. At the time shown in FIG. 3, the teeth 33 are on a “rising” circumferential point of the rotating cam disk 32, and the teeth 35 are on a “falling” circumferential point. The covered parts of the teeth 33, 35 are not illustrated by dashed lines. For further information on the cam disk transmission 31, reference is made to patent DE 10 2006 042 786 B4, in which such a transmission is described in more detail.

Teeth 33 and 35 are part of the gear rim and are arranged displaced radially in a tooth cage 36. The tooth cage 36 is connected to an output shaft (not shown). During operation, the teeth 33, 35 are driven radially by the cam disk 32 and the internal toothing arrangement 40. Since fewer teeth are present along the circumference of the tooth cage 36 than gaps between the teeth in the internal toothing arrangement 40 of the fixed ring gear, the circumferential engagement of the teeth 33, 35 in the internal toothing arrangement 40 results in a rotational movement of the tooth cage 36.

In order to avoid tilting or rotation of the teeth 33, 35 when the component pieces 11, 12 of the ring gear rotate in opposite directions, in each case four teeth 33 or 35 are arranged behind one another in the axial direction in a tooth row 37, as is shown in detail in FIG. 5. It is to be borne in mind that when the component pieces 11, 12 rotate in opposite directions, for example by 1/20 of a tooth pitch, some of the four teeth of a tooth row 37 engage with the internal toothing arrangement 40 with their rear edge in the circumferential direction and others with their front edge in the circumferential direction. As a result, torque about a radial axis is applied to the tooth row 37. In order to prevent rotation, in each case four teeth 33, 35 are therefore arranged in a tooth row 37 and correspondingly grasped in the tooth cage 36. In each case two teeth 33, 35 are mounted together in a double packet, with the result that a row composed of four teeth 33, 35 from two double packets of teeth 33, 35 is assembled.

Alternative embodiments with a divided ring gear have two teeth in a tooth row. The two teeth are combined to form one double packet and mounted together. The provision of two teeth provides the advantage of a relatively simple design. In embodiments with two cam disks or with two gear rims or tooth cages, at least four teeth in a row provide particular advantages in respect of the stability of the transmission.

In other embodiments of the invention, at least three or four component pieces are provided which are displaceable relative to one another. In particular in the case of a cam disk transmission, this provides the advantage that loading the teeth with torque about a radial axis of the transmission, i.e. about a longitudinal axis of the teeth, can be avoided by correspondingly actuating the component pieces.

FIG. 6 shows once more the outlines of the planetary gear mechanism 1 in FIG. 1 in schematic form. In addition, a control unit 51 which controls the actuators of the planetary gear mechanism 1 and is supplied with energy is shown in FIG. 5. Furthermore, the control unit 51 receives, from the planetary gear mechanism 1, rotational angle information which represents the position of components for planetary gear mechanism 1, that is to say for example angular positions of the drive shaft 52.

A drive shaft 52 of the planetary gear mechanism is connected to an engine 53 which drives the planetary gear mechanism 1. The engine 53 is controlled by a controller 54. On the output side of the planetary gear mechanism 1, an output shaft 55 is provided. The control unit also determines or receives information about the angular positions of the drive shaft 52 or of the output shaft 55. This information can be determined from the rotational angle information of the planetary gear mechanism 1. A further possibility is to determine the information by evaluating data of the controller 54. The control unit 51 actuates the actuators of the planetary gear mechanism 1 as a function of this information and on the basis of information from a characteristic diagram which is stored in a memory 56 of the control unit 51. In particular embodiments, only the position of the planetary gear mechanism 1 is determined in order to obtain prescriptions for actuating the actuators from the characteristic diagram.

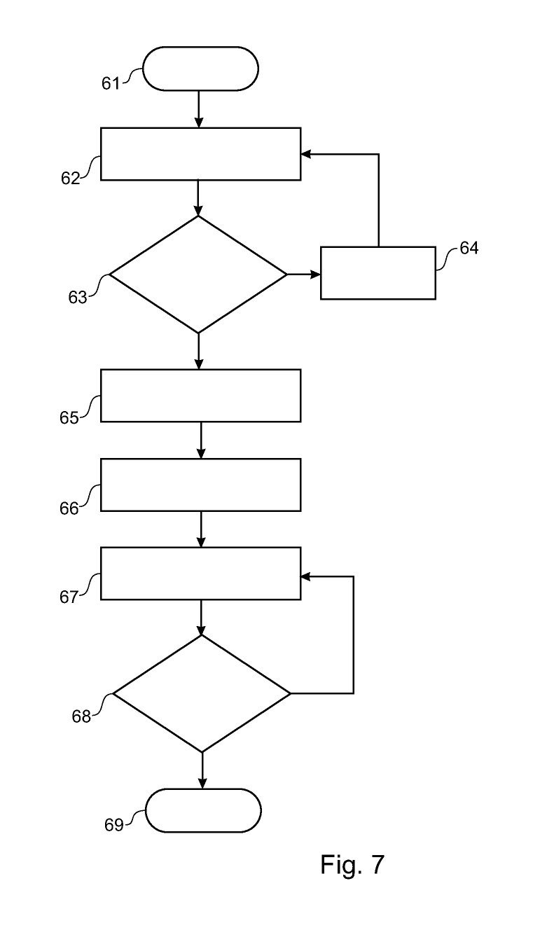

FIG. 7 shows the sequence of a method according to the invention for operating the planetary gear mechanism 1 in a highly schematic flow diagram. The method is started in a first step 61. Then, the recording of the characteristic diagram is begun in a step 62. The characteristic diagram contains information about the geometry of the planetary gear mechanism 1, in particular about deviations in the diameter or radii of the individual planetary gears 6, of the sun gear 5 and of the component pieces 11, 12 of the ring gear. As a result of tolerances due to manufacture, the individual components are, for example, not exactly circular, with the result that during operation slight deviations in the true running or in the clearance of the planetary gear mechanism 1 occur, depending on the position in which the individual components are. One possible way of recording the geometric information is to operate the planetary gear mechanism with different clearance by varying the position of the two component pieces 11, 12, in order to determine which clearance is respectively present in various angular positions or positions of the planetary gear mechanism 1. As far as this application uses the terms “position” or “angular position” for the transmission, the angular position of the rotating parts of the transmission, such as for example the drive shaft or output shaft, is generally meant unless there are other indications. Furthermore, the clearance at a position can also be determined directly by operating the planetary gear mechanism in opposite directions.

True running of the transmission is determined in other embodiments. For this purpose, a sensor such as, for example, a measurement clock, is preferably arranged on the output shaft of the transmission in order to determine the true running.

In step 62, clearance is determined for a first position of the planetary gear mechanism 1 with various positioning of the component pieces 11, 12, in order to determine an optimum position for the component pieces 11, 12. The “optimum” position can be optimized with respect to a specific clearance or minimized clearance or with respect to true running. Various characteristic diagrams are advantageously stored for various applications, such as reduction in clearance or improvement in true running. In a step 63 it is then interrogated whether clearance also has to be determined for further positions of the planetary gear mechanism 1. If this is the case, the planetary gear mechanism 1 is rotated to the further position in a step 64 and the step 62 is repeated at this position. In this way, the characteristic diagram is filled with information. Further information for all the possible positionings of the components are preferably collected in 0.5° increments of the planetary gear mechanism.

After all the required information has been collected, the characteristic diagram is stored in the memory of the control unit in step 65. The usual operation of the planetary gear mechanism 1 begins in step 66, wherein the position of the components of the planetary gear mechanism 1 is determined by means of at least one position sensor, in particular a rotational angle signal generator on the drive shaft, which is connected to the sun gear 5, or rotational angle signal generator on the output shaft, which is connected to the planetary gears 6. As a rule, one rotational angle signal generator is sufficient since the other information can be calculated from the kinematics of the transmission. Then, in step 67 a setpoint position for the component pieces 11, 12 is determined for this position or positioning, and the actuators 15, 18 are correspondingly actuated in order to reduce the clearance to a desired amount or to improve the true running. In this context there is also provision for a controller which controls an engine which drives the planetary gear mechanism 1 to be able to predefine to the control unit 51 whether the planetary gear mechanism is to be operated in a first mode in the fast gear speed with a large amount of clearance or in a second mode for precise positioning with little clearance. The step 67 is repeated for as long as the planetary gear mechanism 1 is operated (step 68). The method ends otherwise in step 69.

The invention is not restricted to the exemplary embodiments described above, in particular not to embodiments with a fixed ring gear as a machine element, but rather the scope of protection is determined by the claims.

1. A ring gear for a transmission comprising an internal toothing arrangement, wherein the ring gear is divided, in a plane perpendicular to an axis of the ring gear, into at least two component pieces which can be displaced relative to one another and which are mounted on a common carrier element, wherein an actuator is provided for displacing a first of the component pieces relative to the carrier element.

2. The ring gear according to claim 1, wherein the first component piece is connected to the carrier element via at least three actuators.

3. The ring gear according to claim 2, wherein the at least three actuators form a first actuator set for displacing the first component piece, and further including a second actuator set having at least three further actuators for displacing the second component piece relative to the carrier element.

4. The ring gear according to claim 3, wherein the first and second actuator sets comprise a piezoelement and/or a shape memory alloy.

5. The ring gear according to claim 4, further including a control unit for actuating the first and second actuator sets.

6. Transmission, in particular coaxial transmission comprising an internal toothing arrangement, with a ring gear comprising an internal toothing arrangement, wherein the ring gear is divided, in a plane perpendicular to an axis of the ring gear, into at least two component pieces which can be displaced relative to one another and which are mounted on a common carrier element, wherein an actuator is provided for displacing a first of the component pieces relative to the carrier element.

7. Transmission according to claim 6, wherein the transmission is a planetary gear mechanism.

8. Transmission according to claim 6, wherein the transmission comprises an internal cam disk, and a gear rim which is arranged between the ring gear and the cam disk, the gear rim has radially movable teeth which can be driven by the cam disk.

9. Method for operating the transmission as claimed in claim 8, comprising the steps of:
determining an angular position of a drive shaft, of an output shaft, of a sun gear, of a ring gear and/or of a planetary gear as in input variable;
determining a setpoint position for at least one of the component pieces of the ring gear as a function of the input variable; and
actuating the actuator as a function of the setpoint position.

10. Method according to claim 9, including the step of operating the transmission in order to determine a characteristic diagram.

11. Method according to claim 10, wherein the transmission is operated in a first mode and subsequently in a second mode, wherein in the first mode and in the second mode the component pieces are each positioned in such a way that clearance of the transmission is greater in the first mode than in the second mode.
